(19) United States
(12) Patent Application Publication
(10) Pub. No.: US 2026/0261448 A1
(43) Pub. Date: Sep. 3, 2026

(54) Sharing Intelligence-Derived Information in Home Networks

(71) Applicant: Google LLC, Mountain View, CA (US)

(72) Inventors: Marco Cavalli, Oakland, CA (US); Alexei Sakhartchouk, Waterloo (CA); Brian Matthew Patenaude, Cambridge (CA); Michele Maurice Turner, Portola Valley, CA (US); Karen Chia Lin Yao, Los Altos, CA (US)

(73) Assignee: Google LLC, Mountain View, CA (US)

(21) Appl. No.: 18/846,886

(22) PCT Filed: May 5, 2023
(86) PCT No.: PCT/US2023/066692

§ 371 Date: Sep. 13, 2024

Related U.S. Application Data
(60) Provisional application No. 63/364,458, filed on May 10, 2022.

(51) Int. Cl. H04L 12/28

(52) U.S. Cl. CPC H04L 12/2827

(57) ABSTRACT

Techniques and devices for sharing intelligence-derived information by a hub in a home network are described in which the hub exposes a virtual device including one or more clusters on the home network and receives from a partner device a request to subscribe to a cluster of the one or more clusters. The hub receives state information from an intelligence service, stores the received state information as an attribute of the cluster, and publishes the attribute of the cluster to the partner device, the publishing being effective to direct the partner device to determine whether to perform a local action based on the attribute. Alternatively, the hub receives, from a partner device, an advertisement of a custom cluster installed at the partner device and provides state information by sending a command to the custom cluster at the partner device, the command being indicative of the received state information.

### BACKGROUND

Using wireless networking to connect devices to each other and to cloud-based services is increasingly popular for sensing environmental conditions, controlling equipment, and providing information and alerts to users for residential and commercial buildings. Many devices on wireless networks are designed to operate for extended periods of time on battery-power which limits the available computing, user interface, and radio resources in the devices.

This increasing popularity has led to multiple vendor-specific ecosystems of devices and networking protocols that may not interoperate. To improve the user experience with these devices and networks, standards, such as the Matter standard, are under development to provide interoperability between devices and services of multiple vendors. Many legacy smart home systems make use of limited intelligence, such as determining occupant presence, to create useful automations. However, there are opportunities in multi-vendor systems using a home network to share intelligence-derived information to create automations that are more meaningful to the end user.

### SUMMARY

This summary is provided to introduce simplified concepts of sharing intelligence-derived information in home networks. The simplified concepts are further described below in the Detailed Description. This summary is not intended to identify essential features of the claimed subject matter, nor is it intended for use in determining the scope of the claimed subject matter.

In aspects, methods, devices, systems, and means for sharing intelligence-derived information by a hub in a home network are described in which the hub exposes a virtual device including one or more clusters on the home network and receives from a partner device a request to subscribe to a cluster of the one or more clusters. The hub receives state information from an intelligence service, stores the received state information as an attribute of the cluster, and publishes the attribute of the cluster to the partner device, the publishing being effective to direct the partner device to determine whether to perform a local action based on the attribute.

In aspects, methods, devices, systems, and means for sharing intelligence-derived information by a hub in a home network are described in which the hub receives, from a partner device, an advertisement of a custom cluster installed at the partner device. The hub receives state information from an intelligence service that is associated with the custom cluster, filters the received state information to determine that the partner device can receive the state information, and sends a command to the custom cluster at the partner device, the command being indicative of the received state information.

The details of one or more implementations are set forth in the accompanying drawings and the following description. Other features and advantages will be apparent from the description and drawings and from the claims. This summary is provided to introduce subject matter that is further described in the Detailed Description and Drawings. Accordingly, this summary should not be considered to describe essential features nor used to limit the scope of the claimed subject matter.

### BRIEF DESCRIPTION OF THE DRAWINGS

Aspects of sharing intelligence-derived information in home networks are described with reference to the following drawings. The same numbers are used throughout the drawings to reference like features and components:

FIG. 1 illustrates an example network environment in which various aspects of sharing intelligence-derived information in home networks can be implemented.

FIG. 2 illustrates an example home area network system in which various aspects of sharing intelligence-derived information in home networks can be implemented.

FIG. 3 illustrates an example system in accordance with aspects of sharing intelligence-derived information in home networks.

FIG. 4 illustrates example data and control transactions between devices in accordance with aspects of sharing intelligence-derived information in home networks can be implemented.

FIG. 5 illustrates an example method of sharing intelligence-derived information in home networks as in accordance with aspects of the techniques described herein.

FIG. 6 illustrates an example method of sharing intelligence-derived information in home networks as in accordance with aspects of the techniques described herein.

FIG. 7 illustrates an example environment in which a home area network can be implemented in accordance with aspects of the techniques described herein.

FIG. 8 illustrates an example wireless network device that can be implemented in a home area network environment in accordance with one or more aspects of the techniques described herein.

FIG. 9 illustrates an example system with an example device that can implement aspects of sharing intelligence-derived information in home networks.

### DETAILED DESCRIPTION

This document describes techniques and devices to provide clusters on a home network (e.g., Matter network, Weave network, fabric network) to share intelligence-derived information that enable third-party smart home device makers to improve automation experiences for users. By providing this information through clusters provided on a such a local network (such as via a virtual device hosted by a hub device on the network), device manufacturers can use intelligence models around the home, the users in the home, their activities, and their context to build automations while safeguarding users' privacy and security by relying on a local connectivity protocol.

Centrally-managed automations, such as those managed through a cloud service, may have limited capabilities, such as describing a home presence state of users in the home (e.g., home or away states). This centrally-managed approach with a platform that provides identical capabilities may limit the ability of device manufactures to innovate and differentiate their products and solutions. Third-party device manufacturers may lack the skills, resources, and/or the necessary sensor input to build accurate models to develop their own intelligence models. An ecosystem provider has a much greater ability to provide synthesized intelligence signals from a large array of devices.

In aspects, a smart-home ecosystem provider can develop sophisticated models around the home, its users (e.g., home or room presence), their activities (e.g., sleeping, working, watching a movie), and the broader home context (e.g., proactive maintenance, external events). These models enable the smart-home ecosystem provider as well as third-party device manufacturers to use the intelligence these models provide locally on network-enabled smart home devices on a home network (e.g., Matter-enabled device on a home network using the Matter protocol). For example, hubs from the smart-home ecosystem provider can expose a virtual device on the local network, the virtual device having a number of clusters (intelligence clusters), each of which models one specific intelligence type, such as a home presence cluster.

Third-party developers of a network-enabled device can use a software development Kit (SDK) and its associated Application Programming Interfaces (APIs) to expose the intelligence clusters on the third-party network-enabled device or the third-party device can subscribe to intelligence clusters on a hub. When a network-enabled device that supports intelligence clusters is paired with a smart-home ecosystem provider hub on the home-network, the network-enabled third-party device can receive notifications from the smart-home ecosystem provider hub, over the local network, when one of the intelligence clusters state changes (e.g., users leave the home). The network-enabled device can use the state change notification to trigger custom logic, locally on the device, to perform actions in response to the state change (e.g., lower the room temperature). To provide user privacy and security, users must provide consent (e.g., at the smart-home ecosystem provider hub) in order for a network-enabled device to receive intelligence clusters-related notifications. Users can revoke or modify consent at any time.

### Example Environment

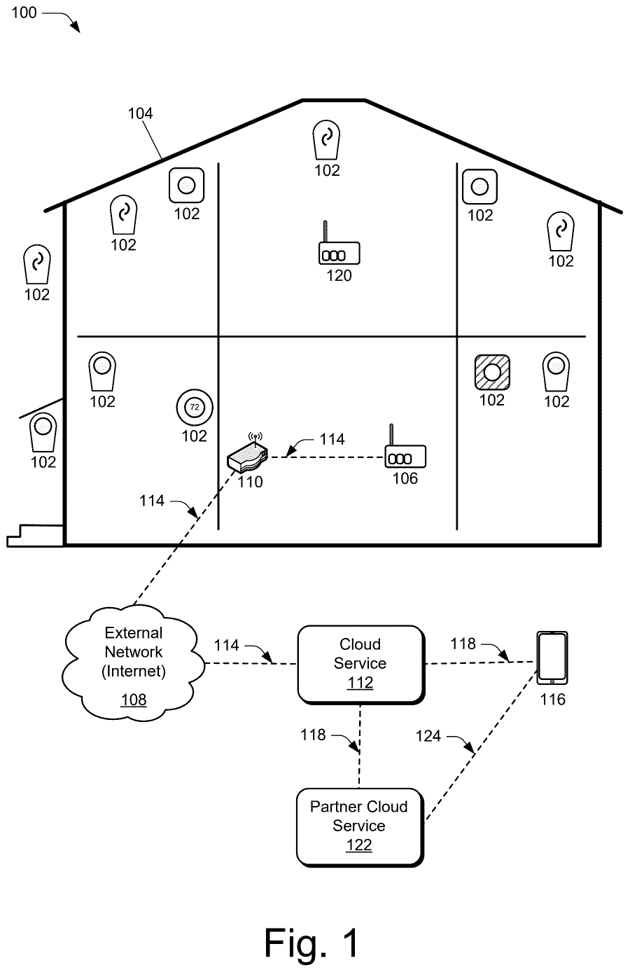

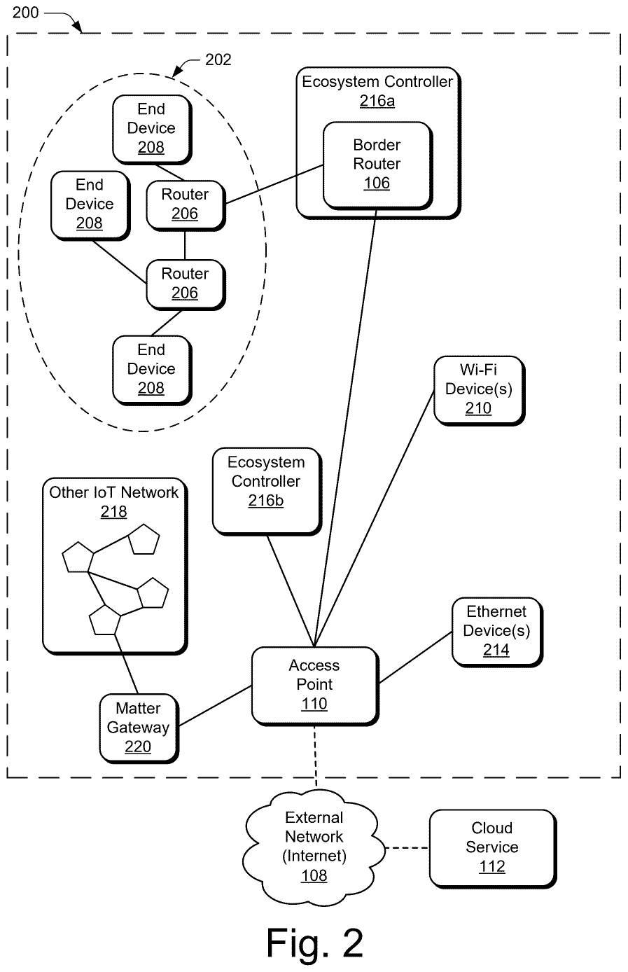

FIG. 1 illustrates an example network environment 100 in which aspects of sharing intelligence-derived information in home networks can be implemented. The network environment 100 includes a home area network (HAN) such as a HAN 200, described below with respect to FIG. 2. The HAN includes wireless network devices 102 that are disposed about a structure 104, such as a house, and are connected by one or more wireless and/or wired network technologies, as described below. The HAN includes a border router 106 that connects the HAN to an external network 108, such as the Internet, through a home router or access point 110.

To provide user access to functions implemented using the wireless network devices 102 in the HAN, a cloud service 112 connects to the HAN via border router 106, via a secure tunnel 114 through the external network 108 and the access point 110. The cloud service 112 facilitates communication between the HAN and internet clients 116, such as apps on mobile devices, using a web-based application programming interface (API) 118. The cloud service 112 also manages a home graph that describes connections and relationships between the wireless network devices 102, elements of the structure 104, and users. The cloud service 112 hosts controllers which orchestrate and arbitrate home automation experiences, as described in greater detail below.

The HAN may include one or more wireless network devices 102 that function as a hub 120. The hub 120 may be a general-purpose home automation hub, a network-connected speaker, or an application-specific hub, such as a security hub, an energy management hub, an HVAC hub, and so forth. The functionality of a hub 120 may also be integrated into any wireless network device 102, such as a smart thermostat device or the border router 106. In addition to hosting controllers on the cloud service 112, controllers can be hosted on any hub 120 in the structure 104, such as the border router 106. A controller hosted on the cloud service 112 can be moved dynamically to the hub 120 in the structure 104, such as moving an HVAC zone controller to a newly installed smart thermostat.

Hosting functionality on the hub 120 in the structure 104 can improve reliability when the user's internet connection is unreliable, can reduce latency of operations that would normally have to connect to the cloud service 112, and can satisfy system and regulatory constraints around local access between wireless network devices 102. For example, the hub 120 in a Matter network can host the intelligence clusters and provide user access controls for access to the intelligence clusters.

The wireless network devices 102 in the HAN may be from a single manufacturer that provides the cloud service 112 as well, or the HAN may include wireless network devices 102 from partners (third-party devices). These partners may also provide partner cloud services 122 that provide services related to their wireless network devices 102 through a partner Web API 124. The partner cloud service 122 may optionally or additionally provide services to internet clients 116 via the web-based API 118, the cloud service 112, and the secure tunnel 114.

The network environment 100 can be implemented on a variety of hosts, such as battery-powered microcontroller-based devices, line-powered devices, and servers that host cloud services. Protocols operating in the wireless network devices 102 and the cloud service 112 provide a number of services that support operations of home automation experiences in the distributed computing environment 100. These services include, but are not limited to, real-time distributed data management and subscriptions, command-and-response control, real-time event notification, historical data logging and preservation, cryptographically controlled security groups, time synchronization, network and service pairing, and software updates.

FIG. 2 illustrates an example home area network system (e.g., Matter network, Weave network, fabric network) in which various aspects of sharing intelligence-derived information in home networks can be implemented. The home area network (HAN) 200 (Matter network 200) includes a wireless mesh network 202 (e.g., a Thread network) and Wi-Fi device(s) 210. The HAN 200 may also include wired network devices (e.g., Ethernet device(s) 214). The wireless mesh network 202 includes routers 206 and end devices 208. The routers 206 and the end devices 208, each include a mesh network interface for communication over the mesh network 202. The routers 206 receive and transmit packet data over the mesh network interface. The routers 206 also route traffic across the mesh network 202. The end devices 208 are devices that can communicate using the mesh network 202, but lack the capability, beyond simply forwarding to its parent router 206, to route traffic in the mesh network 202. For example, a battery-powered sensor is one type of end device 208. Each Wi-Fi device 210 includes a Wi-Fi network interface for communication over a Wi-Fi network. The Wi-Fi devices 210 and/or the Ethernet devices 214 can include home automation devices as well as devices that include applications to control Matter devices (e.g., a smartphone, a tablet, a network-connected speaker).

An ecosystem controller 216a (e.g., a Matter controller) can include the border router 106, which in turn, is included in the wireless mesh network 202. The border router 106 includes a mesh network interface for communication over the mesh network 202 and a Wi-Fi network interface for communication over the Wi-Fi network 204, or the border router 106 uses the Wi-Fi network interface of the ecosystem controller 216a for communication over the Wi-Fi network 204. The border router 106 routes packets between devices in the wireless mesh network 202 and the access point 110, which can forward packets to other devices in the HAN 200. The border router 106 also routes packets between devices in the mesh network 202 and external network nodes (e.g., the cloud service 112) via the external network 108, such as the Internet, through a home router or access point 110.

The HAN 200 includes one or more ecosystem controllers 216 that provide an interface between devices from an ecosystem vendor and the access point 110. For example, the ecosystem controller 216a provides an interface between the mesh network 202 (a Thread network) and the access point 110. Optionally, the HAN 200 may include other ecosystem controllers, such as ecosystem controller 216b, to interface to devices from other ecosystem vendors. Additionally, other, devices from another IoT network 218 (e.g., non-Matter compatible ecosystem devices) can be connected to the access point 110 by a Matter gateway 220 that provides connectivity for Matter-capable applications to devices in the other IoT network 218.

The devices in the mesh network 202, the Wi-Fi device(s) 210, the Ethernet device(s) 214, the ecosystem controllers 216, and Matter gateway 220 use standard IP routing configurations to communicate with each other through transport protocols such as the User Datagram Protocol (UDP) or the Transmission Control Protocol (TCP).

### Sharing Intelligence-Derived Information in Home Networks

In Matter, clusters are functional elements of a data model. A cluster specification defines both a client and server side of a cluster that correspond with each other through interactions. A cluster is an interface, a service, or an object class. The definition of each cluster includes elements of the cluster including attributes, events, commands, as well as behavior associated with interactions with these elements.

A cluster is a specification defining one or more attributes, commands, behaviors and dependencies, that supports an independent utility or application function. The term cluster may also be used for an implementation or instance of such a specification on an endpoint device in the home network. An attribute is a data entity which represents a physical quantity or state. State information may be any information relating to the structure (home) such as a measured quantity like a temperature measured by a device in the home network, a state of an entity such as whether a window or a door is open or closed as reported by a sensor in the home network, or a derived state such as whether occupants of the structure are home or away based on information derived from sensors (e.g., occupancy sensors in the home network) and/or attributes (e.g., a home-away schedule, a calendar, data from a cloud-based service). This attribute (data) is communicated to other nodes in the home network using commands. A command is a request for action on a value with an expected response which may have parameters and a response with a status and parameters.

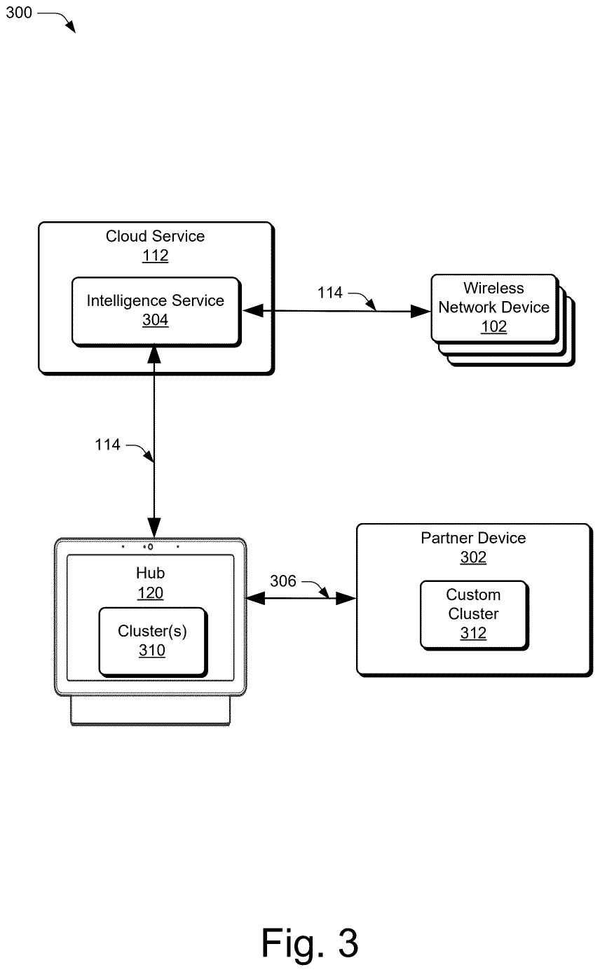

FIG. 3 illustrates an example system in accordance with aspects of sharing intelligence-derived information in home networks. The system includes the cloud service 112, the hub 120 (hub node 120), wireless network devices 102, and a partner device 302 (partner node 302) that is a Matter-capable device. The cloud service 112 includes an intelligence service 304.

As described with respect to FIG. 1, the wireless network devices 102 and the hub 120 are connected via the secure tunnel 114 to the cloud service 112 of the smart-home ecosystem provider. The partner device 302 and the hub 120 are commissioned to, and communicate over, the Matter network 306. The intelligence service 304 receives inputs from various wireless network devices 102 and/or the hub 120. The intelligence service 304 analyzes these inputs, historical information, the contents of the home graph maintained by the cloud service 112, and/or external information using learning technology (e.g., artificial intelligence, machine learning, deep neural networks, or the like) to draw inferences about the home, its users, their activities, and/or the broader home context.

The intelligence service 304 generates intelligence signals that populate Custom Clusters (e.g., intelligence clusters), illustrated as the cluster(s) 310, and are used to describe the custom Matter clusters defined by the smart-home ecosystem provider. The intelligence clusters are used to expose intelligence signals to the partner device 302. In a first alternative, the partner device 302 subscribes to the cluster 310 at the hub and when a state changes the hub reports data to the partner device 302. In a second alternative, the partner manufacturer deploys a custom cluster 312 on the partner device 302. When there is an intelligence signal sent from the intelligence service 304 to the hub 120, the hub 120 filters state information to determine that the partner device 302 can receive the intelligence signal, and the hub 120 sends a command to the custom cluster 312 to signal the intelligence signal state change to the partner device 302. For example, the intelligence signals include home presence signals that provide a Matter device with a Home and an Away signal through the hub 120.

After being commissioned to the Matter network that includes the hub 120, the partner device 302 registers with the hub 120 for an approved cluster endpoint or the partner device reports its capabilities by advertising the custom cluster 312 to the hub 120. The hub 120 authenticates the node and subscribes with the cloud service 112 and/or intelligence service 304 to the required signals and/or traits of the intelligence cluster requested by the partner device 302 and approved by the user. The hub 120 notifies the partner device 302 of any intelligence cluster state changes to which the partner device 302 has subscribed by reporting data in the first alternative or by sending a command to the custom cluster 312.

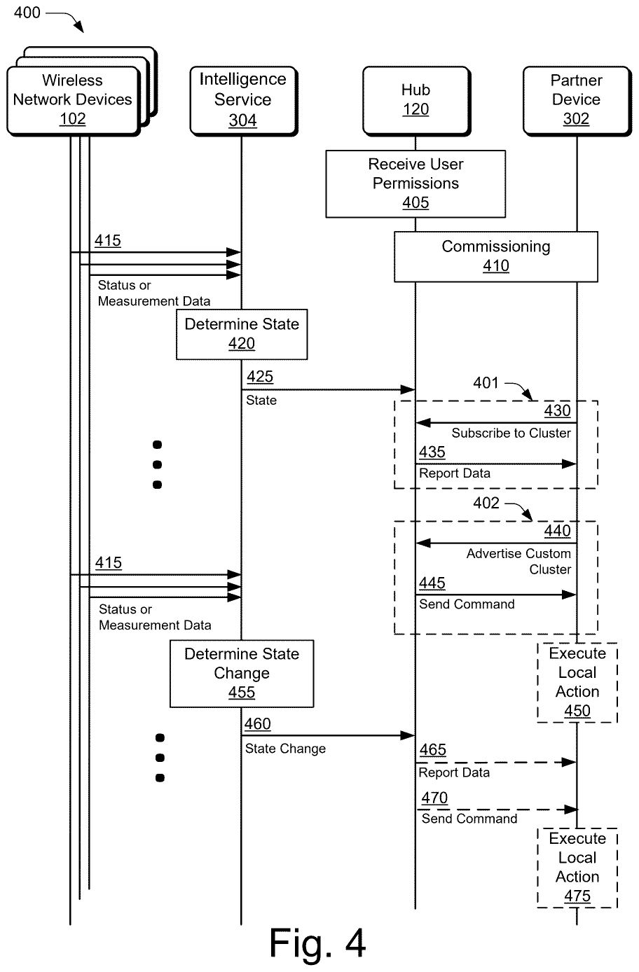

FIG. 4 illustrates an example of transactions among various network entities in accordance with aspects of sharing intelligence-derived information in home networks. At 405, the hub 120 receives an input of permissions for partner device 302 to access information from one or more intelligence clusters. The permissions may grant access to one or more clusters and/or only to specific states within the one or more clusters. For example, the user may grant access to home and away states for the entire home from the presence cluster but not to access to presence information for individual rooms and/or more granular user activity information, such as the occupants being in a sleeping state as well as being at home. The user permissions can be received as part of the commissioning of the partner device 302 to the Matter network (as shown at 410) or may be provided or changed at any other time. After commissioning and receiving user permissions, the hub 120 exposes a virtual Matter device on the local, Matter network. The virtual Matter device includes a number of clusters 310 including the intelligence clusters. Alternatively, the hub device 120 itself provides the intelligence clusters to which devices can subscribe.

At 415 and periodically thereafter, the wireless network devices and/or other sources of status information provide status information and/or sensor measurement data to the intelligence service 304. The wireless network devices 102 provide status information and/or sensor measurement data at periodic intervals or based on a status change (e.g., detecting a change in a state, based on a measurement value crossing a threshold value, or the like). In one option, the status information and/or sensor measurement data may be stored in the home graph maintained by the cloud service 112 and accessed from the home graph by the intelligence service 304.

At 420, the intelligence service 304 determines state information, such as presence information and at 425 the intelligence service 304 provides the state information (intelligence signals) to the hub 120. The intelligence service 304 may provide the state information periodically and/or based upon determining a state change. The hub 120 stores the state information in a cluster 310 (e.g., storing the state information as an attribute included in the cluster) or sends it directly to its client devices.

In the first alternative at 401, at 430, the partner device 302 subscribes to a cluster 310 of the virtual Matter device exposed by the hub 120 using a Matter SubscribeRequestMessage. At 435, the hub 120 checks cluster states and reports (publishes) data for the subscribed clusters to the partner device 302 in a Matter ReportDataMessage. In the second alternative at 402, the partner device 302, at 440, advertises the custom cluster 312 to the hub 120 and, at 445 the hub sends a command indicative of the state information to the customer cluster 312. Optionally at 450, based on the received data or received command, the partner device 302 may determine to perform a local action based on the received data or received command.

At 455, the intelligence service 304 determines a change in state information, such as presence information, and at 460, the intelligence service 304 provides the state change information to the hub 120. At 465, the hub 120 publishes the data for the state change to the partner device 302 in a Matter ReportDataMessage or at 470 the hub sends a command indicative of the state change information to the customer cluster 312. Optionally, at 475, based on the received data or received command, the partner device 302 may determine to perform a local action.

### Example Methods

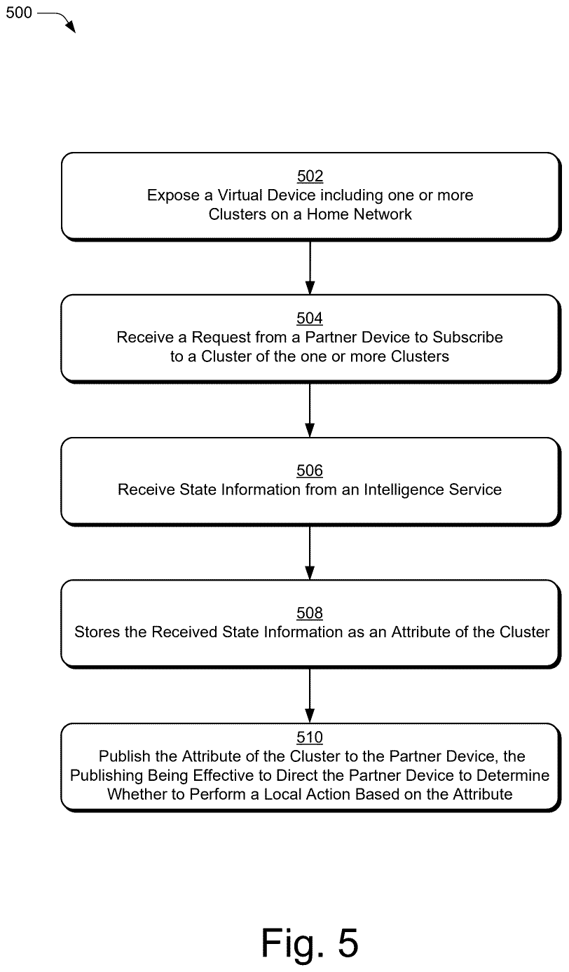

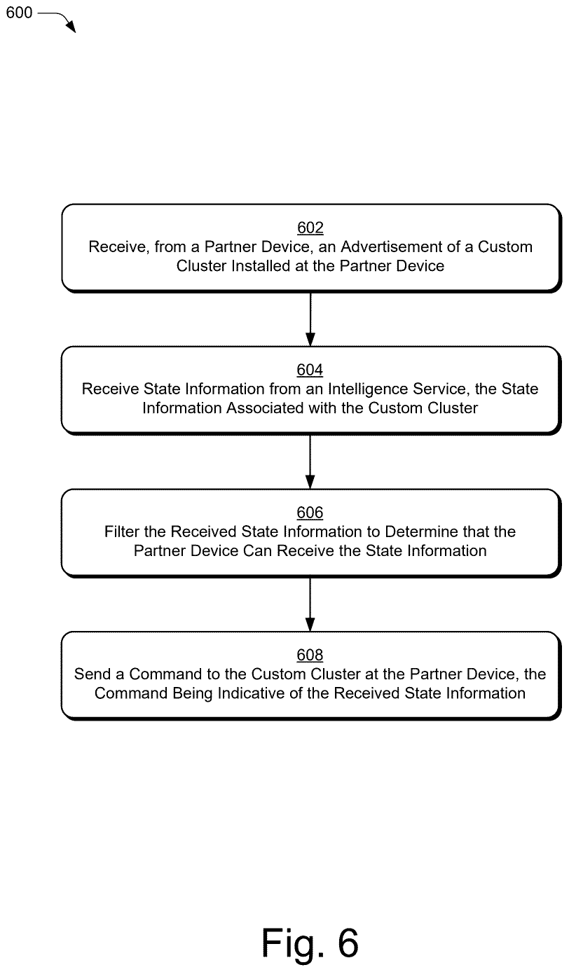

Example methods 500 and 600 are described with reference to FIGS. 5 and 6 in accordance with one or more aspects of sharing intelligence-derived information in home networks. Generally, any of the components, modules, methods, and operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like. The order in which the method blocks are described is not intended to be construed as a limitation, and any number of the described method blocks can be combined in any order or skipped to implement a method or an alternate method.

FIG. 5 illustrates example method(s) 500 of sharing intelligence-derived information in home networks as generally related to a hub that exposes an intelligence cluster on a Matter network. At block 502, a hub exposes a virtual device including one or more clusters on a home network. For example, a hub (e.g., the hub 120) exposes a virtual device that includes one or more clusters (e.g., clusters 310), such as an intelligence cluster and/or a presence cluster.

At block 504, the hub receives a request from a partner device to subscribe to a cluster of the one or more clusters. For example, the hub receives a Matter SubscribeRequestMessage from a partner device (e.g., the partner device 302) to request to subscribe to attributes of a cluster (e.g., the cluster 310) of the one or more clusters, as described with respect to 430.

At block 506, the hub device receives state information from an intelligence service. For example, the hub device receives state information (at 425 and 450) from an intelligence service (e.g., the intelligence service 304).

At block 508, the hub device stores the received state information as an attribute of the cluster. For example, the hub device stores the state information as an attribute in a cluster associated with the received state information.

At block 510, the hub device publishes the attribute of the cluster to the partner device, the publishing being effective to direct the partner device to determine whether to perform a local action based on the attribute. For example, the hub device publishes the attribute of the cluster to the partner device in a Matter ReportDataMessage, as described with respect to 435 and 455.

FIG. 6 illustrates example method(s) 600 of sharing intelligence-derived information in home networks as generally related to a hub that exposes an intelligence cluster on a Matter network. At block 602, a hub receives, from a partner device, an advertisement of a custom cluster installed at the partner device. For example, a hub (e.g., the hub 120) receives an advertisement of a custom cluster (e.g., the custom cluster 312), at 440, from a partner device (e.g., the partner device 302). The custom cluster receives one or more commands that comprises information indicative of state information received by the hub device in intelligence signals from a cloud service (e.g., the intelligence service 304).

At block 604, the hub receives state information from an intelligence service, the state information associated with the custom cluster, similar to what happens at 425, for instance. For example, the hub receives intelligence signals indicating state information that the custom cluster is configured to receive and potentially take action based on the state information, such as a change in a home presence state of users in the home.

At block 606, the hub filters the received state information to determine that the partner device can receive the state information. For example, the hub device determines whether the partner device previously advertised the custom cluster associated with the state information received from the intelligence service. The intelligence service may determine which devices will receive the state information at the point the intelligence signals are sent to the hub. The hub will use the determination (e.g., a list of devices from the intelligence service) to filter the state information to the appropriate devices.

At block 608, based on filtering the received state information, the hub sends a command to the custom cluster at the partner device, the command being indicative of the received state information, similar to what happens at 445, for instance. For example, based on the partner device being included in the list of devices received from the intelligence service, the hub sends a command (a message) that indicates the received state information or includes a parameter indicative of the state information.

### Example Environments and Devices

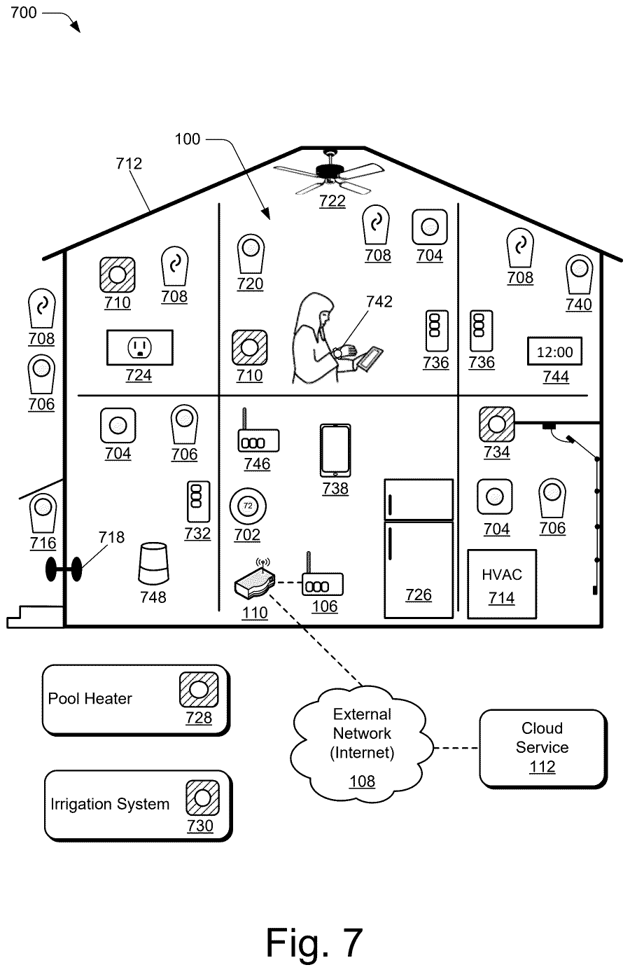

FIG. 7 illustrates an example environment 700 in which a home area network 200, as described with reference to FIG. 2, and aspects of sharing intelligence-derived information in home networks can be implemented. Generally, the environment 700 includes the home area network (HAN) 200 implemented as part of a home or other type of structure with any number of wireless and/or wired network devices that are configured for communication in a wireless network. For example, the wireless network devices can include a thermostat 702, hazard detectors 704 (e.g., for smoke and/or carbon monoxide), cameras 707 (e.g., indoor and outdoor), lighting units 708 (e.g., indoor and outdoor), and any other types of wireless network devices 710 that are implemented inside and/or outside of a structure 712 (e.g., in a home environment). In this example, the wireless network devices can also include any of the previously described devices, such as a border router 106, as well as any of the devices implemented as a router device 206, an end device 208, an ecosystem controller 216, and/or a Matter gateway 220.

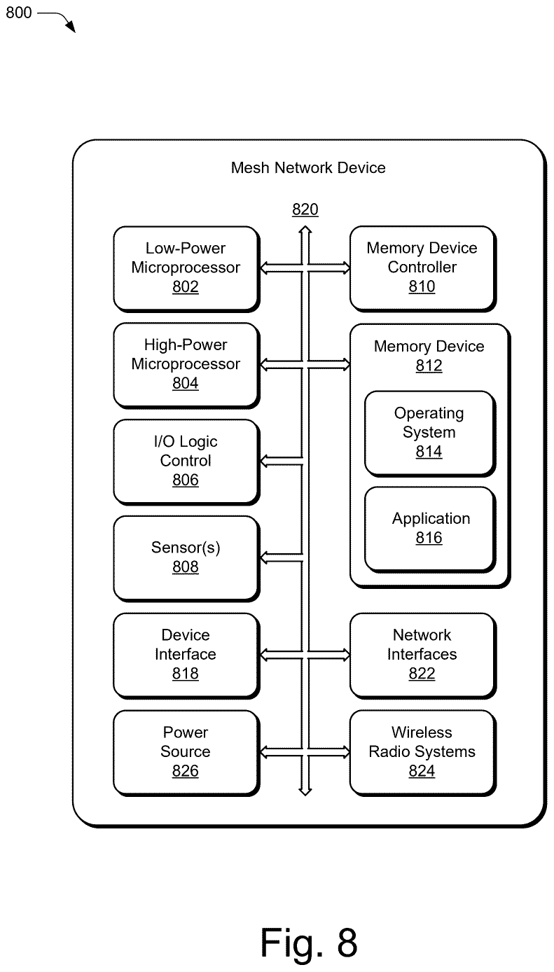

In the environment 700, any number of the wireless network devices can be implemented for wireless interconnection to wirelessly communicate and interact with each other. The wireless network devices are modular, intelligent, multi-sensing, network-connected devices that can integrate seamlessly with each other and/or with a central server or a cloud-computing system to provide any of a variety of useful automation objectives and implementations. An example of a wireless network device that can be implemented as any of the devices described herein is shown and described with reference to FIG. 8.

In implementations, the thermostat 702 may include a Nest® Learning Thermostat that detects ambient climate characteristics (e.g., temperature and/or humidity) and controls a HVAC system 714 in the home environment. The learning thermostat 702 and other network-connected devices “learn” by capturing occupant settings to the devices. For example, the thermostat learns preferred temperature set-points for mornings and evenings, and when the occupants of the structure are asleep or awake, as well as when the occupants are typically away or at home.

A hazard detector 704 can be implemented to detect the presence of a hazardous substance or a substance indicative of a hazardous substance (e.g., smoke, fire, or carbon monoxide). In examples of wireless interconnection, a hazard detector 704 may detect the presence of smoke, indicating a fire in the structure, in which case the hazard detector that first detects the smoke can broadcast a low-power wake-up signal to all of the connected wireless network devices. The other hazard detectors 704 can then receive the broadcast wake-up signal and initiate a high-power state for hazard detection and to receive wireless communications of alert messages. Further, the lighting units 708 can receive the broadcast wake-up signal and activate in the region of the detected hazard to illuminate and identify the problem area. In another example, the lighting units 708 may activate in one illumination color to indicate a problem area or region in the structure, such as for a detected fire or break-in, and activate in a different illumination color to indicate safe regions and/or escape routes out of the structure.

In various configurations, the wireless network devices 710 can include an entryway interface device 716 that functions in coordination with a network-connected door lock system 718, and that detects and responds to a person's approach to or departure from a location, such as an outer door of the structure 712. The entryway interface device 716 can interact with the other wireless network devices based on whether someone has approached or entered the smart-home environment. An entryway interface device 716 can control doorbell functionality, announce the approach or departure of a person via audio or visual means, and control settings on a security system, such as to activate or deactivate the security system when occupants come and go. The wireless network devices 710 can also include other sensors and detectors, such as to detect ambient lighting conditions, detect room-occupancy states (e.g., with an occupancy sensor 720), and control a power and/or dim state of one or more lights. In some instances, the sensors and/or detectors may also control a power state or speed of a fan, such as a ceiling fan 722. Further, the sensors and/or detectors may detect occupancy in a room or enclosure and control the supply of power to electrical outlets or devices 724, such as if a room or the structure is unoccupied.

The wireless network devices 710 may also include connected appliances and/or controlled systems 726, such as refrigerators, stoves and ovens, washers, dryers, air conditioners, pool heaters 728, irrigation systems 730, security systems 732, and so forth, as well as other electronic and computing devices, such as televisions, network-connected televisions, network-connected media streaming devices, entertainment systems, computers, intercom systems, garage-door openers 734, ceiling fans 722, control panels 736, and the like. When plugged in, an appliance, device, or system can announce itself to the home area network as described above and can be automatically integrated with the controls and devices of the home area network, such as in the home. It should be noted that the wireless network devices 710 may include devices physically located outside of the structure, but within wireless communication range, such as a device controlling a swimming pool heater 728 or an irrigation system 730.

As described above, the mesh network 202 includes a border router 106 that interfaces for communication with an external network, outside the mesh network 202. The border router 106 connects to an access point 110, which connects to the communication network 108, such as the Internet. A cloud service 112, which is connected via the communication network 108, provides services related to and/or using the devices within the HAN 200. By way of example, the cloud service 112 can include applications for connecting end user devices 738, such as smartphones, tablets, and the like, to devices in the home area network, processing and presenting data acquired in the HAN 200 to end users, linking devices in one or more HANs 200 to user accounts of the cloud service 112, provisioning and updating devices in the HAN 200, and so forth. For example, a user can control the thermostat 702 and other wireless network devices in the home environment using a network-connected computer or portable device, such as a mobile phone or tablet device. Further, the wireless network devices can communicate information to any central server or cloud-computing system via the border router 106, an ecosystem controller 216, a Matter gateway 220, and/or the access point 110. The data communications can be carried out using any of a variety of custom or standard wireless protocols (e.g., Wi-Fi, ZigBee for low power, 6LoWPAN, Thread, BLE, Matter, etc.) and/or by using any of a variety of custom or standard wired protocols (Ethernet, HomePlug, etc.).

Any of the wireless network devices in the HAN 200 can serve as low-power and communication nodes to create the HAN 200 in the home environment. Individual low-power nodes of the network can regularly send out messages regarding what they are sensing, and the other low-powered nodes in the environment-in addition to sending out their own messages-can repeat the messages, thereby communicating the messages from node to node (i.e., from device to device) throughout the home area network. The wireless network devices can be implemented to conserve power, particularly when battery-powered, utilizing low-powered communication protocols to receive the messages, translate the messages to other communication protocols, and send the translated messages to other nodes and/or to a central server or cloud-computing system. For example, an occupancy and/or ambient light sensor can detect an occupant in a room as well as measure the ambient light, and activate the light source when the ambient light sensor 740 detects that the room is dark and when the occupancy sensor 720 detects that someone is in the room. Further, the sensor can include a low-power wireless communication chip (e.g., an IEEE 802.15.4 chip, a Thread chip, a ZigBee chip) that regularly sends out messages regarding the occupancy of the room and the amount of light in the room, including instantaneous messages coincident with the occupancy sensor detecting the presence of a person in the room. As mentioned above, these messages may be sent wirelessly, using the home area network, from node to node (i.e., network-connected device to network-connected device) within the home environment as well as over the Internet to a central server or cloud-computing system.

In other configurations, various ones of the wireless network devices can function as “tripwires” for an alarm system in the home environment. For example, in the event a perpetrator circumvents detection by alarm sensors located at windows, doors, and other entry points of the structure or environment, the alarm could still be triggered by receiving an occupancy, motion, heat, sound, etc. message from one or more of the low-powered mesh nodes in the home area network. In other implementations, the home area network can be used to automatically turn on and off the lighting units 708 as a person transitions from room to room in the structure. For example, the wireless network devices can detect the person's movement through the structure and communicate corresponding messages via the nodes of the home area network. Using the messages that indicate which rooms are occupied, other wireless network devices that receive the messages can activate and/or deactivate accordingly. As referred to above, the home area network can also be utilized to provide exit lighting in the event of an emergency, such as by turning on the appropriate lighting units 708 that lead to a safe exit. The light units 708 may also be turned-on to indicate the direction along an exit route that a person should travel to safely exit the structure.

The various wireless network devices may also be implemented to integrate and communicate with wearable computing devices 742, such as may be used to identify and locate an occupant of the structure, and adjust the temperature, lighting, sound system, and the like accordingly. In other implementations, RFID sensing (e.g., a person having an RFID bracelet, necklace, or key fob), synthetic vision techniques (e.g., video cameras and face recognition processors), audio techniques (e.g., voice, sound pattern, vibration pattern recognition), ultrasound sensing/imaging techniques, and infrared or near-field communication (NFC) techniques (e.g., a person wearing an infrared or NFC-capable smartphone), along with rules-based inference engines or artificial intelligence techniques that draw useful conclusions from the sensed information as to the location of an occupant in the structure or environment.

In other implementations, personal comfort-area networks, personal health-area networks, personal safety-area networks, and/or other such human-facing functionalities of service robots can be enhanced by logical integration with other wireless network devices and sensors in the environment according to rules-based inferencing techniques or artificial intelligence techniques for achieving better performance of these functionalities. In an example relating to a personal health-area, the system can detect whether a household pet is moving toward the current location of an occupant (e.g., using any of the wireless network devices and sensors), along with rules-based inferencing and artificial intelligence techniques. Similarly, a hazard detector service robot can be notified that the temperature and humidity levels are rising in a kitchen, and temporarily raise a hazard detection threshold, such as a smoke detection threshold, under an inference that any small increases in ambient smoke levels will most likely be due to cooking activity and not due to a genuinely hazardous condition. Any service robot that is configured for any type of monitoring, detecting, and/or servicing can be implemented as a mesh node device on the home area network, conforming to the wireless interconnection protocols for communicating on the home area network.

The wireless network devices 710 may also include a network-connected alarm clock 744 for each of the individual occupants of the structure in the home environment. For example, an occupant can customize and set an alarm device for a wake time, such as for the next day or week. Artificial intelligence can be used to consider occupant responses to the alarms when they go off and make inferences about preferred sleep patterns over time. An individual occupant can then be tracked in the home area network based on a unique signature of the person, which is determined based on data obtained from sensors located in the wireless network devices, such as sensors that include ultrasonic sensors, passive IR sensors, and the like. The unique signature of an occupant can be based on a combination of patterns of movement, voice, height, size, etc., as well as using facial recognition techniques.

In an example of wireless interconnection, the wake time for an individual can be associated with the thermostat 702 to control the HVAC system in an efficient manner so as to pre-heat or cool the structure to desired sleeping and awake temperature settings. The preferred settings can be learned over time, such as by capturing the temperatures set in the thermostat before the person goes to sleep and upon waking up. Collected data may also include biometric indications of a person, such as breathing patterns, heart rate, movement, etc., from which inferences are made based on this data in combination with data that indicates when the person actually wakes up. Other wireless network devices can use the data to provide other automation objectives, such as adjusting the thermostat 702 so as to pre-heat or cool the environment to a desired setting and turning-on or turning-off the lights 708.

In implementations, the wireless network devices can also be utilized for sound, vibration, and/or motion sensing such as to detect running water and determine inferences about water usage in a home environment based on algorithms and mapping of the water usage and consumption. This can be used to determine a signature or fingerprint of each water source in the home and is also referred to as “audio fingerprinting water usage.” Similarly, the wireless network devices can be utilized to detect the subtle sound, vibration, and/or motion of unwanted pests, such as mice and other rodents, as well as by termites, cockroaches, and other insects. The system can then notify an occupant of the suspected pests in the environment, such as with warning messages to help facilitate early detection and prevention.

The environment 700 may include one or more wireless network devices that function as a hub 746. The hub 746 may be a general-purpose home automation hub, or an application-specific hub, such as a security hub, an energy management hub, an HVAC hub, and so forth. The functionality of a hub 746 may also be integrated into any wireless network device, such as a network-connected thermostat device or the border router 106. Hosting functionality on the hub 746 in the structure 712 can improve reliability when the user's internet connection is unreliable, can reduce latency of operations that would normally have to connect to the cloud service 112, and can satisfy system and regulatory constraints around local access between wireless network devices.

Additionally, the example environment 700 includes a network-connected-speaker 748. The network-connected speaker 748 provides voice assistant services that include providing voice control of network-connected devices. The functions of the hub 746 may be hosted in the network-connected speaker 748. The network-connected speaker 748 can be configured to communicate via the wireless mesh network 202, the Wi-Fi network 204, or both.

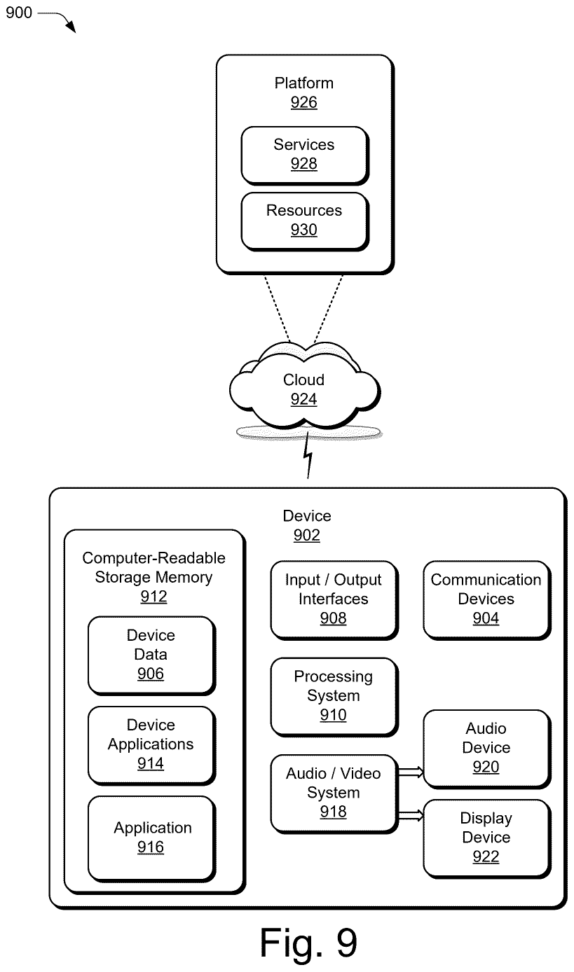

FIG. 8 illustrates an example wireless network device 800 that can be implemented as any of the wireless network devices in a home area network (Thread network, Matter network) in accordance with one or more aspects of sharing intelligence-derived information in home networks as described herein. The device 800 can be integrated with electronic circuitry, microprocessors, memory, input output (I/O) logic control, communication interfaces and components, as well as other hardware, firmware, and/or software to implement the device in a home area network. Further, the wireless network device 800 can be implemented with various components, such as with any number and combination of different components as further described with reference to the example device shown in FIG. 9.

In this example, the wireless network device 800 includes a low-power microprocessor 802 and a high-power microprocessor 804 (e.g., microcontrollers or digital signal processors) that process executable instructions. The device also includes an input-output (I/O) logic control 806 (e.g., to include electronic circuitry). The microprocessors can include components of an integrated circuit, programmable logic device, a logic device formed using one or more semiconductors, and other implementations in silicon and/or hardware, such as a processor and memory system implemented as a system-on-chip (SoC). Alternatively or in addition, the device can be implemented with any one or combination of software, hardware, firmware, or fixed logic circuitry that may be implemented with processing and control circuits. The low-power microprocessor 802 and the high-power microprocessor 804 can also support one or more different device functionalities of the device. For example, the high-power microprocessor 804 may execute computationally intensive operations, whereas the low-power microprocessor 802 may manage less-complex processes such as detecting a hazard or temperature from one or more sensors 808. The low-power processor 802 may also wake or initialize the high-power processor 804 for computationally intensive processes.

The one or more sensors 808 can be implemented to detect various properties such as acceleration, temperature, humidity, water, supplied power, proximity, external motion, device motion, sound signals, ultrasound signals, light signals, fire, smoke, carbon monoxide, global-positioning-satellite (GPS) signals, radio frequency (RF), other electromagnetic signals or fields, or the like. As such, the sensors 808 may include any one or a combination of temperature sensors, humidity sensors, hazard-related sensors, security sensors, other environmental sensors, accelerometers, microphones, optical sensors up to and including cameras (e.g., charged coupled-device or video cameras, active or passive radiation sensors, GPS receivers, and radio frequency identification detectors. In implementations, the wireless network device 800 may include one or more primary sensors, as well as one or more secondary sensors, such as primary sensors that sense data central to the core operation of the device (e.g., sensing a temperature in a thermostat or sensing smoke in a smoke detector), while the secondary sensors may sense other types of data (e.g., motion, light or sound), which can be used for energy-efficiency objectives or automation objectives.

The wireless network device 800 includes a memory device controller 810 and a memory device 812, such as any type of a nonvolatile memory and/or other suitable electronic data storage device. The wireless network device 800 can also include various firmware and/or software, such as an operating system 814 that is maintained as computer executable instructions by the memory and executed by a microprocessor. The device software may also include an application 816 that implements aspects of sharing intelligence-derived information in home networks. The wireless network device 800 also includes a device interface 818 to interface with another device or peripheral component and includes an integrated data bus 820 that couples the various components of the wireless network device for data communication between the components. The data bus in the wireless network device may also be implemented as any one or a combination of different bus structures and/or bus architectures.

The device interface 818 may receive input from a user and/or provide information to the user (e.g., as a user interface), and a received input can be used to determine a setting. The device interface 818 may also include mechanical or virtual components that respond to a user input. For example, the user can mechanically move a sliding or rotatable component, or the motion along a touchpad may be detected, and such motions may correspond to a setting adjustment of the device. Physical and virtual movable user-interface components can allow the user to set a setting along a portion of an apparent continuum. The device interface 818 may also receive inputs from any number of peripherals, such as buttons, a keypad, a switch, a microphone, and an imager (e.g., a camera device).

The wireless network device 800 can include network interfaces 822, such as a home area network interface for communication with other wireless network devices in a home area network, and an external network interface for network communication, such as via the Internet. The wireless network device 800 also includes wireless radio systems 824 for wireless communication with other wireless network devices via the home area network interface and for multiple, different wireless communications systems. The wireless radio systems 824 may include Wi-Fi, Bluetooth™, Mobile Broadband, BLE, and/or point-to-point IEEE 802.15.4. Each of the different radio systems can include a radio device, antenna, and chipset that is implemented for a particular wireless communications technology. The wireless network device 800 also includes a power source 826, such as a battery and/or to connect the device to line voltage. An AC power source may also be used to charge the battery of the device.

FIG. 9 illustrates an example system 900 that includes an example device 902, which can be implemented as any of the wireless network devices that implement aspects of sharing intelligence-derived information in home networks as described with reference to the previous FIGS. 1-8. The example device 902 may be any type of computing device, client device, mobile phone, tablet, communication, entertainment, gaming, media playback, and/or other type of device. Further, the example device 902 may be implemented as any other type of wireless network device that is configured for communication on a home area network, such as a thermostat, hazard detector, camera, light unit, commissioning device, router, border router, joiner router, joining device, end device, leader, access point, and/or other wireless network devices.

The device 902 includes communication devices 904 that enable wired and/or wireless communication of device data 906, such as data that is communicated between the devices in a home area network, data that is being received, data scheduled for broadcast, data packets of the data, data that is synched between the devices, etc. The device data can include any type of communication data, as well as audio, video, and/or image data that is generated by applications executing on the device. The communication devices 904 can also include transceivers for cellular phone communication and/or for network data communication.

The device 902 also includes input/output (I/O) interfaces 908, such as data network interfaces that provide connection and/or communication links between the device, data networks (e.g., a home area network, external network, etc.), and other devices. The I/O interfaces can be used to couple the device to any type of components, peripherals, and/or accessory devices. The I/O interfaces also include data input ports via which any type of data, media content, and/or inputs can be received, such as user inputs to the device, as well as any type of communication data, as well as audio, video, and/or image data received from any content and/or data source.

The device 902 includes a processing system 910 that may be implemented at least partially in hardware, such as with any type of microprocessors, controllers, and the like that process executable instructions. The processing system can include components of an integrated circuit, programmable logic device, a logic device formed using one or more semiconductors, and other implementations in silicon and/or hardware, such as a processor and memory system implemented as a system-on-chip (SoC). Alternatively or in addition, the device can be implemented with any one or combination of software, hardware, firmware, or fixed logic circuitry that may be implemented with processing and control circuits. The device 902 may further include any type of a system bus or other data and command transfer system that couples the various components within the device. A system bus can include any one or combination of different bus structures and architectures, as well as control and data lines.

The device 902 also includes computer-readable storage memory 912 (computer-readable storage media 912), such as data storage devices that can be accessed by a computing device, and that provide persistent storage of data and executable instructions (e.g., software applications, modules, programs, functions, and the like). The computer-readable storage memory described herein excludes propagating signals. Examples of computer-readable storage memory include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage memory in various memory device configurations.

The computer-readable storage memory 912 provides storage of the device data 906 and various device applications 914, such as an operating system that is maintained as a software application with the computer-readable storage memory and executed by the processing system 910. The device applications may also include a device manager, such as any form of a control application, software application, signal processing and control module, code that is native to a particular device, a hardware abstraction layer for a particular device, and so on. In this example, the device applications also include an application 916 that implements aspects of sharing intelligence-derived information in home networks, such as when the example device 902 is implemented as any of the wireless network devices described herein.

The device 902 also includes an audio and/or video system 918 that generates audio data for an audio device 920 and/or generates display data for a display device 922. The audio device and/or the display device include any devices that process, display, and/or otherwise render audio, video, display, and/or image data, such as the image content of a digital photo. In implementations, the audio device and/or the display device are integrated components of the example device 902. Alternatively, the audio device and/or the display device are external, peripheral components to the example device. In aspects, at least part of the techniques described for common interface for sharing intelligence-derived information in home networks may be implemented in a distributed system, such as over a “cloud” 924 in a platform 926. The cloud 924 includes and/or is representative of the platform 926 for services 928 and/or resources 930.

The platform 926 abstracts underlying functionality of hardware, such as server devices (e.g., included in the services 928) and/or software resources (e.g., included as the resources 930), and connects the example device 902 with other devices, servers, etc. The resources 930 may also include applications and/or data that can be utilized while computer processing is executed on servers that are remote from the example device 902. Additionally, the services 928 and/or the resources 930 may facilitate subscriber network services, such as over the Internet, a cellular network, or Wi-Fi network. The platform 926 may also serve to abstract and scale resources to service a demand for the resources 930 that are implemented via the platform, such as in an interconnected device aspect with functionality distributed throughout the system 900. For example, the functionality may be implemented in part at the example device 902 as well as via the platform 926 that abstracts the functionality of the cloud 924.

In the following some examples are described:

### Example 1

A method of sharing intelligence-derived information by a hub in a home network, the method comprising the hub:
exposing a virtual device on the home network, the virtual device including one or more clusters;
receiving, from a partner device, a request to subscribe to a cluster of the one or more clusters;
receiving state information from an intelligence service, the state information associated with the cluster;
storing the received state information as an attribute of the cluster; and
publishing the attribute of the cluster to the partner device, the publishing being effective to direct the partner device to determine whether to perform a local action based on the attribute.

### Example 2

The method of example 1, further comprising the hub:
receiving an input of permissions for access to the one or more clusters.

### Example 3

The method of example 2, wherein the permissions determine which attributes of the one or more clusters to which the partner device may subscribe.

### Example 4

The method of any one of the preceding examples, wherein the home network is a Matter network, wherein the virtual device is a virtual Matter device, and wherein the partner device is a Matter device.

### Example 5

The method of any one of the preceding examples, wherein the one or more clusters include:
an intelligence cluster;
a presence cluster; or
both the intelligence cluster and the presence cluster.

### Example 6

The method of any one of the preceding examples, wherein the receiving the request to subscribe to the cluster comprises:
receiving a Matter SubscribeRequestMessage to request to subscribe to the cluster.

### Example 7

The method of any one of the preceding examples, wherein the publishing the attribute of the cluster to the partner device comprises:
publishing the attribute of the cluster to the partner device in a Matter ReportDataMessage.

### Example 8

A method of sharing intelligence-derived information by a hub in a home network, the method comprising the hub:
receiving, from a partner device, an advertisement of a custom cluster installed at the partner device;
receiving state information, from an intelligence service, the state information associated with the custom cluster;
filtering the received state information to determine that the partner device can receive the state information; and
based on the filtering the received state information, sending a command to the custom cluster at the partner device, the command being indicative of the received state information.

### Example 9

The method of example 8, the method further comprising the hub:
receiving, from the intelligence service, a list of devices that are eligible to receive the state information.

### Example 10

The method of example 9, wherein the filtering the received state information to determine that the partner device can receive the state information comprises:
determining that the partner device is included in the list of devices that are eligible to receive the state information.

### Example 11

The method of any one of examples 8 to 10, wherein the home network is a Matter network, and wherein the partner device is a Matter device.

### Example 12

An electronic device comprising:
a network interface;
a processor; and
computer-readable storage media comprising instructions that, responsive to execution by the processor, direct the electronic device to perform a method as recited in any one of examples 1 to 11.

### Example 13

A non-transitory computer-readable storage medium comprising instructions for a hub node, the instructions executable by one or more processors, to configure the hub node to perform a method as recited in any one of examples 1 to 11.

### Example 14

A system comprising a hub in a home network and a partner device, wherein:
the hub is configured to:
   expose a virtual device on the home network, the virtual device including one or more clusters;
   receive, from the partner device, a request to subscribe to a cluster of the one or more clusters;
   receive state information from an intelligence service, the state information associated with the cluster;
   store the received state information as an attribute of the cluster; and
   publish the attribute of the cluster to the partner device,
and wherein the partner device is configured to, in response to the publishing, determine whether to perform a local action based on the attribute.

### Example 15

Software code comprising instructions which, when executed, cause:
a hub in a home network is to:
   expose a virtual device on the home network, the virtual device including one or more clusters;
   receive, from the partner device, a request to subscribe to a cluster of the one or more clusters;
   receive state information from an intelligence service, the state information associated with the cluster;
   store the received state information as an attribute of the cluster; and
   publish the attribute of the cluster to the partner device,
and cause a partner device to, in response to the publishing, determine whether to perform a local action based on the attribute.

Although aspects of sharing intelligence-derived information in home networks have been described in language specific to features and/or methods, the subject of the appended claims is not necessarily limited to the specific features or methods described. Rather, the specific features and methods are disclosed as example implementations of sharing intelligence-derived information in home networks, and other equivalent features and methods are intended to be within the scope of the appended claims. Further, various different aspects are described, and it is to be appreciated that each described aspect can be implemented independently or in connection with one or more other described aspects.

1. A method of sharing intelligence-derived information by a hub in a home network, the method comprising the hub:
exposing a virtual device on the home network, the virtual device including one or more clusters;
receiving, from a partner device, a request to subscribe to a cluster of the one or more clusters;
receiving state information from an intelligence service, the state information associated with the cluster;
storing the received state information as an attribute of the cluster; and
publishing the attribute of the cluster to the partner device, the publishing being effective to direct the partner device to determine whether to perform a local action based on the attribute.

2. The method of claim 1, further comprising the hub:
receiving an input of permissions for access to the one or more clusters.

3. The method of claim 2, wherein the permissions determine to which attributes of the one or more clusters the partner device may subscribe.

4. The method of claim 1, wherein the home network is a Matter network, wherein the virtual device is a virtual Matter device, and wherein the partner device is a Matter device.

5. The method of claim 4, wherein the receiving the request to subscribe to the cluster comprises:
receiving a Matter SubscribeRequestMessage to request to subscribe to the cluster.

6. The method of claim 4, wherein the publishing the attribute of the cluster to the partner device comprises:
publishing the attribute of the cluster to the partner device in a Matter ReportDataMessage.

7. The method of claim 1, wherein the one or more clusters include:
an intelligence cluster;
a presence cluster; or
both the intelligence cluster and the presence cluster.

8. A method of sharing intelligence-derived information by a hub in a home network, the method comprising the hub:
receiving, from a partner device, an advertisement of a custom cluster installed at the partner device;
receiving state information, from an intelligence service, the state information associated with the custom cluster;
filtering the received state information to determine that the partner device can receive the state information; and
based on the filtering of the received state information, sending a command to the custom cluster at the partner device, the command being indicative of the received state information.

9. The method of claim 8, the method further comprising the hub:
receiving, from the intelligence service, a list of devices that are eligible to receive the state information.

10. The method of claim 9, wherein the filtering the received state information to determine that the partner device can receive the state information comprises:
determining that the partner device is included in the list of devices that are eligible to receive the state information.

11. The method of claim 8, wherein the home network is a Matter network, and wherein the partner device is a Matter device.

12. (canceled)

13. (canceled)

14. An electronic device comprising:
a network interface;
a processor; and
computer-readable storage media comprising instructions executable by the processor to direct the electronic device to:
expose a virtual device on a home network, the virtual device including one or more clusters;
receive, from a partner device, a request to subscribe to a cluster of the one or more clusters;
receive state information from an intelligence service, the state information associated with the cluster;
store the received state information as an attribute of the cluster; and
publish the attribute of the cluster to the partner device, the publishing being effective to direct the partner device to determine whether to perform a local action based on the attribute.

15. The electronic device of claim 14, the instructions further executable by the processor to direct the electronic device to:
receive an input of permissions for access to the one or more clusters.

16. The electronic device of claim 15, wherein the permissions determine to which attributes of the one or more clusters the partner device may subscribe.

17. The electronic device of claim 14, wherein the home network is a Matter network, wherein the virtual device is a virtual Matter device, and wherein the partner device is a Matter device.

18. The electronic device of claim 17, wherein the instructions to receive the request to subscribe to the cluster are further executable to direct the electronic device to:
receive a Matter SubscribeRequestMessage to request to subscribe to the cluster.

19. The electronic device of claim 17, wherein the instructions to publish the attribute of the cluster to the partner device are further executable to direct the electronic device to:
publish the attribute of the cluster to the partner device in a Matter ReportDataMessage.

20. The electronic device of claim 14, wherein the one or more clusters include:
an intelligence cluster;
a presence cluster; or
both the intelligence cluster and the presence cluster.

21. The electronic device of claim 14, wherein the electronic device is a hub device.

22. An electronic device comprising:
a network interface;
a processor; and
computer-readable storage media comprising instructions executable by the processor to direct the electronic device to:
receive, from a partner device, an advertisement of a custom cluster installed at the partner device;
receive state information, from an intelligence service, the state information associated with the custom cluster;
filter the received state information to determine that the partner device can receive the state information; and
based on the filtering of the received state information, send a command to the custom cluster at the partner device, the command being indicative of the received state information.
